(19) United States
(12) Patent Application Publication
(10) Pub. No.: US 2016/0167887 A1
(43) Pub. Date: Jun. 16, 2016

(54) Bin Transport Assembly

(71) Applicant: Orval Windham, Copperas Cove, TX (US)

(72) Inventor: Orval Windham, Copperas Cove, TX (US)

(21) Appl. No.: 14/568,765

(22) Filed: Dec. 12, 2014

(51) Int. Cl. B65G 37/00; B65G 13/00

(52) U.S. Cl. CPC B65G 37/00; B65G 13/00

(57) ABSTRACT

A bin transport assembly for automatically transporting the bins to an entrance of a conveyor belt includes the conveyor belt structured to convey the plurality of bins. The conveyor belt is positioned proximate a security screening area. A trough is structured to receive the bins. A plurality of rollers is coupled to the trough. The rollers transport the bins between each end of the trough. A plurality of legs is coupled to the trough. The legs may support the trough above a support surface. The legs angle the trough so the bins are urged between each end of the trough.

### BACKGROUND OF THE DISCLOSURE

### Field of the Disclosure

The disclosure relates to transport devices and more particularly pertains to a new transport device for automatically transporting bins to an entrance of a conveyor belt.

SUMMARY OF THE DISCLOSURE

An embodiment of the disclosure meets the needs presented above by generally comprising a conveyor belt structured to convey a plurality of bins. The conveyor belt is positioned proximate a security screening area. A trough is structured to receive the bins.

A plurality of rollers is coupled to the trough. The rollers transport the bins between each end of the trough. A plurality of legs is coupled to the trough. The legs may support the trough above a support surface. The legs angle the trough so the bins are urged between each end of the trough.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an in-use top front side perspective view of a bin transport assembly according to an embodiment of the disclosure.

FIG. 2 is a right side cutaway view of an embodiment of the disclosure.

FIG. 3 is a cross sectional view taken along line 3-3 of FIG. 2 of an embodiment of the disclosure.

FIG. 4 is a top view of an embodiment of the disclosure.

FIG. 5 is a top view of an alternative embodiment of the disclosure.

FIG. 6 is an in-use view of a top front side perspective view of an embodiment of the disclosure.

### DESCRIPTION OF THE PREFERRED EMBODIMENT

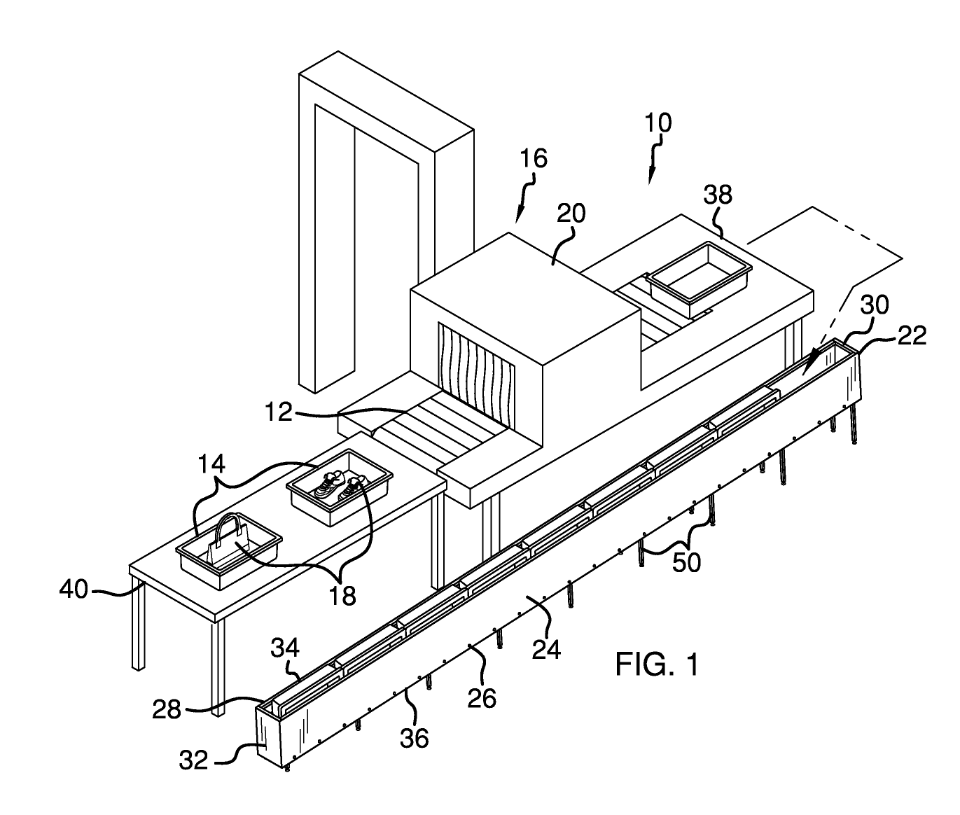

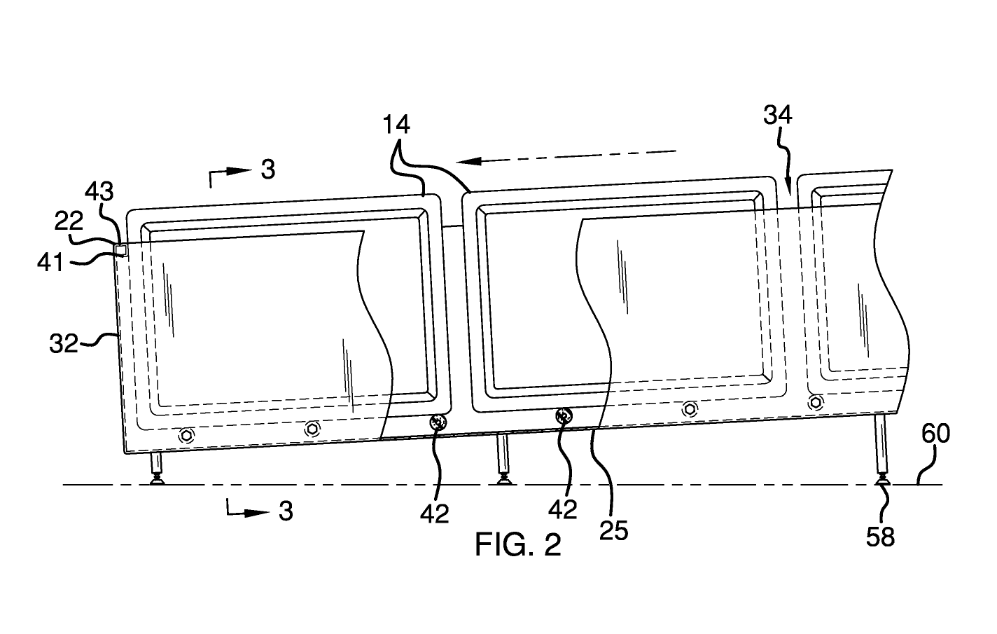

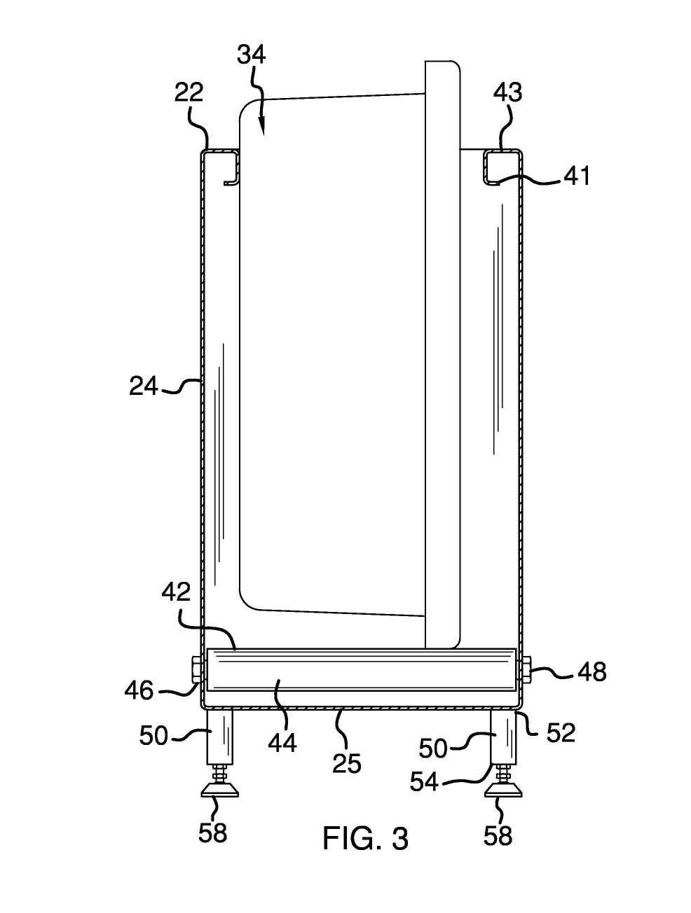

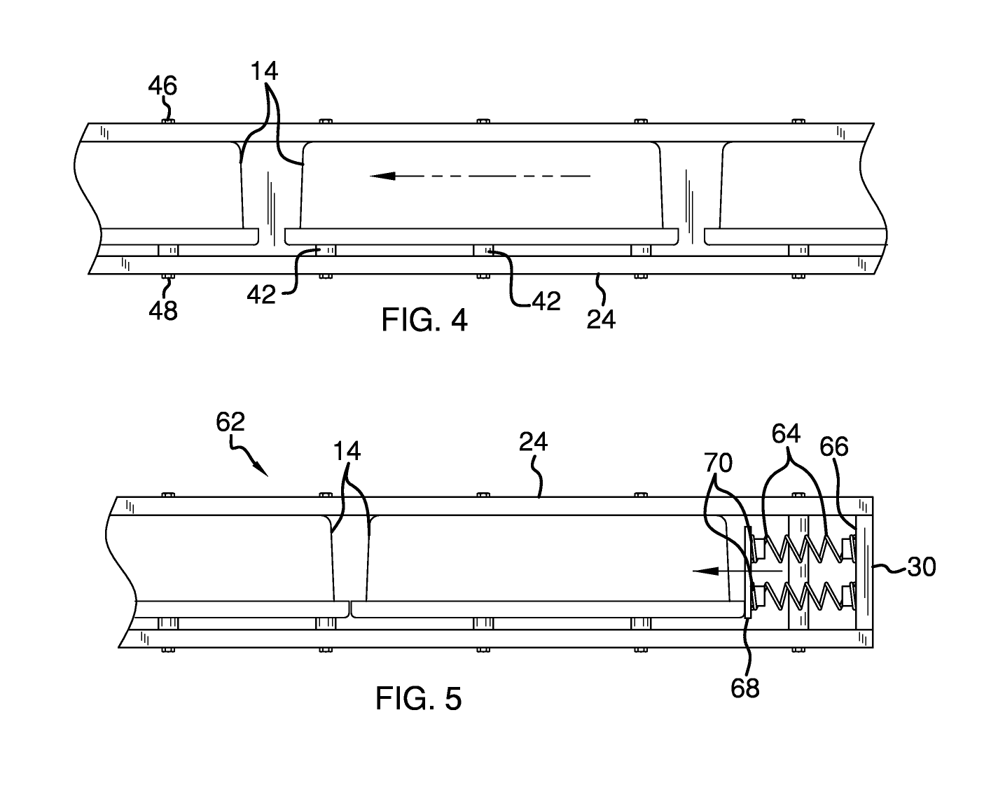

With reference now to the drawings, and in particular to FIGS. 1 through 6 thereof, a new transport device embodying the principles and concepts of an embodiment of the disclosure and generally designated by the reference numeral 10 will be described.

As best illustrated in FIGS. 1 through 6, the bin transport assembly 10 generally comprises a conveyor belt 12 structured to convey a plurality of bins 14. The conveyor belt 12 is positioned proximate a security screening area 16. The security screening area 16 may be an airport security screening area. The bins 14 may contain personal items 18 of individuals engaging in air travel. The conveyor belt 12 may convey the personal items 18 through an X-Ray scanner 20 in the security screening area 16. Additionally, the bins 14 may be airport screening bins of any conventional design.

A trough 22 is provided. The trough 22 has a perimeter wall 24 coupled to an extending upwardly from a bottom wall 25 of the trough. Moreover, the perimeter wall 24 has a first lateral side 26 and a second lateral side 28 that are each spaced apart. The first 26 and second 28 lateral sides of the perimeter wall 24 extend between a front side 30 and a back side 32 of the perimeter wall 24 of the trough 22. The trough 22 has a rectangular parallelepiped shape.

A top side 34 of the perimeter wall 24 of the trough 22 is open so the trough 22 is structured to receive the bins 14. The trough 22 is positioned adjacent to the conveyor belt 12. The front side 30 of the perimeter wall 24 of the trough 22 is positioned proximate an exit 38 of the conveyor belt 12 and the back side 32 of the perimeter wall 24 of the trough 22 is positioned proximate an entrance 40 of the conveyor belt 12. A top edge 41 of the perimeter wall 24 of the trough 22 curves inwardly to form a lip 43 on the top side 34 of the perimeter wall 24 of the trough 22.

A plurality of rollers 42 is provided. The rollers 42 have an outer wall 44 extending between each of a first end 46 and a second end 48 of the rollers 42. The outer wall 44 of the rollers 42 is curvilinear. Moreover, the rollers 42 each have an elongated cylindrical shape.

The first 46 and second 48 ends of the rollers 42 are each rotatably coupled to an associated one of the first 26 and second 28 lateral sides of perimeter wall 24 of the trough 22. The rollers 42 are positioned adjacent to the bottom wall 25 of the perimeter wall 24 of the trough 22. Additionally, the rollers 42 are evenly spaced apart and distributed between the front 30 and back 32 sides of the perimeter wall 24 of the trough 22. The rollers 42 transport the bins 14 between the front 30 and back 32 sides of the perimeter wall 24 of the trough 22.

A plurality of legs 50 is provided. The legs 50 each have a top end 52 and a bottom end 54. The top end 52 of the legs 50 is coupled to the bottom wall 25 of the trough 22. A foot 58 is movably coupled to the bottom end 54 of the legs 50. The feet 58 abut a support surface 60. The support surface 60 may be a floor.

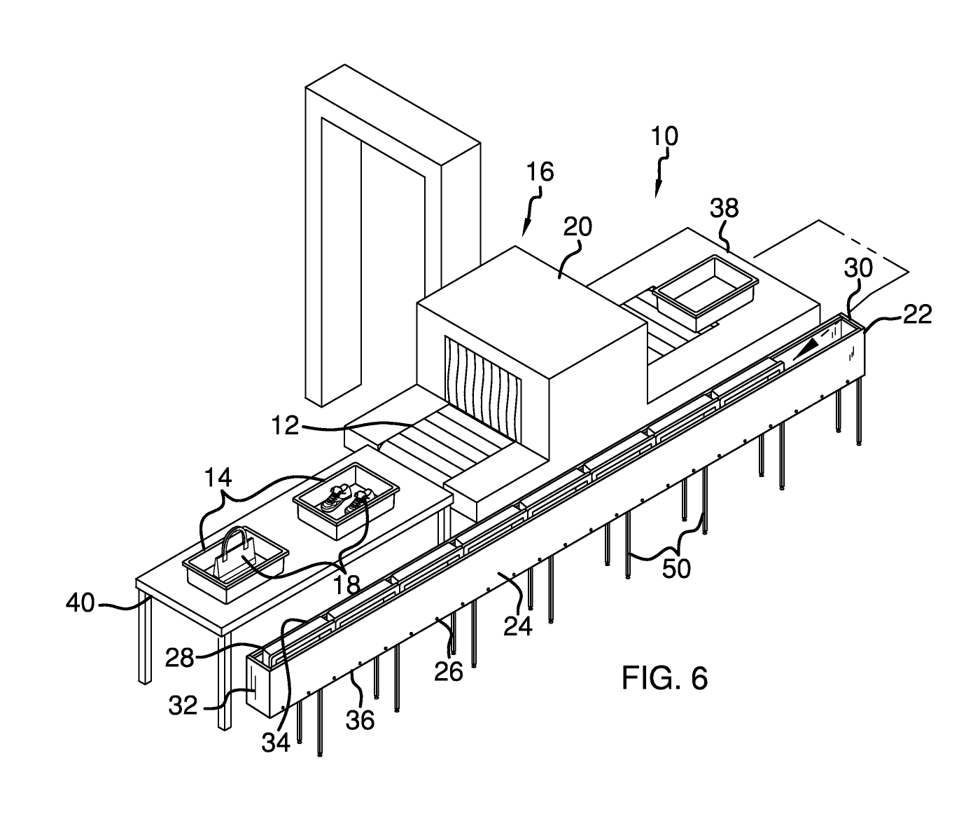

The legs 50 are evenly spaced apart and distributed between the front 30 and back 32 sides of the perimeter wall 24 of the trough 22. The legs 50 have a decreasing length between the front 30 and back 32 sides of the perimeter wall 24 of the trough 22. Moreover, the trough 22 is retained at an angle with respect to the support surface 60. The front side 30 of the perimeter wall 24 of the trough 22 is positioned higher from the support surface 60 than the back side 32 of the perimeter wall 24 of the trough 22. As shown in FIGS. 1 and 6, the legs 50 may be such to position the front 30 adjacent to, as shown in FIG. 6, or below, as shown in FIG. 1, a level of the conveyor belt 12.

Each of the bins 14 are positioned within the trough 12 proximate the front side 30 of the perimeter wall 24 of the trough 22 after the bins 14 is conveyed to the exit 38 of the conveyor belt 12. The bins 14 roll along the rollers 42 toward the back side 32 of the perimeter wall 24 of the trough 22. The bins 14 are available to be positioned on the entrance 40 of the conveyor belt 12.

In an alternative embodiment 62, a pair of spring biasing members 64 are coupled to an inside surface 66 of the front side 30 of the perimeter wall 24 of the trough 22. A plate 68 is coupled to a free end 70 of the pair of spring biasing members 64. The plate 68 engages the bins 14. The spring biasing members 64 urge the bins 14 toward the back side 32 of the perimeter wall 24 of the conveyor belt 12.

In use, each of the bins 14 is positioned within the trough 22 after the bins 14 arrive at the exit 38 of the conveyor belt 12 and the personal items 18 have been removed from the bins 14. The bins 14 are urged toward the entrance 40 of the conveyor belt 12 so the bins 14 are available to be utilized at the entrance 40 of the conveyor belt 12. The assembly 10 allows the bins 14 to be automatically returned to the entrance 40 of the conveyor belt 12 rather than being manually transported to the entrance 40 of the conveyor belt 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bin transport assembly comprising:
a conveyor belt structured to convey a plurality of bins, said conveyor belt being positioned proximate a security screening area;
a trough structured to receive said bins;
a plurality of rollers coupled to said trough such that said rollers transport said bins between each end of said trough; and
a plurality of legs coupled to said trough such that said legs are configured to support said trough above a support surface, said legs angling said trough such that said bins are urged between each end of said trough.

2. The assembly according to claim 1, further comprising said trough having a perimeter wall coupled to and extending upwardly from a bottom wall of the trough, said perimeter wall having a first lateral side and a second lateral side each being spaced apart, said first and second lateral sides of said perimeter wall extending between a front side and a back side of said perimeter wall of said trough such that said trough has a rectangular parallelepiped shape, a top side of said perimeter wall of said trough being open.

3. The assembly according to claim 2, further comprising said trough being positioned adjacent to said conveyor belt such that said front side of said perimeter wall of said trough is positioned proximate an exit of said conveyor belt and said back side of said perimeter wall of said trough is positioned proximate an entrance of said conveyor belt.

4. The assembly according to claim 1, further comprising said rollers having an outer wall extending between each of a first end and a second end of said rollers, said outer wall of said rollers being curvilinear such that said rollers each has an elongated cylindrical shape.

5. The assembly according to claim 4, further comprising:
said trough having a perimeter wall, said perimeter wall of said trough having a first lateral side and a second lateral side extending between a front side and a back side of said perimeter wall of said trough; and
said first and second ends of said rollers each being rotatably coupled to an associated one of said first and second lateral sides of perimeter wall of said trough such that said rollers is positioned adjacent to a bottom wall of said trough.

6. The assembly according to claim 5, further comprising said rollers being evenly spaced apart and distributed between said front and back sides of said perimeter wall of said trough such that said rollers transport said bins between said front and back sides of said perimeter wall of said trough.

7. The assembly according to claim 1, further comprising:
said trough having a perimeter wall, said perimeter wall of said trough having a first lateral side and a second lateral side extending between a front side and a back side of said perimeter wall of said trough;
said legs having a top end and a bottom end; and
said top end of said legs being coupled to a bottom wall of said trough such that said bottom end of said legs abuts the support surface, said legs being evenly spaced apart and distributed between said front and back sides of said perimeter wall of said trough.

8. The assembly according to claim 7, further comprising said legs having a decreasing length between said front and back sides of said perimeter wall of said trough such that said trough is retained at an angle with respect to the support surface.

9. The assembly according to claim 8, further comprising said bins being positioned within said trough proximate said front side of said perimeter wall of said trough after said bins exit said conveyor belt such that said bins roll along said rollers toward said back side of said perimeter wall of said trough wherein said bins are available to be positioned on an entrance to said conveyor belt.

10. A bin transport assembly comprising:
a conveyor belt structured to convey a plurality of bins, said conveyor belt being positioned proximate a security screening area;
a trough, said trough having a perimeter wall coupled to and extending upwardly from a bottom wall of the trough, said perimeter wall having a first lateral side and a second lateral side each being spaced apart, said first and second lateral sides of said perimeter wall extending between a front side and a back side of said perimeter wall of said trough such that said trough has a rectangular parallelepiped shape, a top side of said perimeter wall of said trough being open wherein said trough is structured to receive said bins;
said trough being positioned adjacent to said conveyor belt such that said front side of said perimeter wall of said trough is positioned proximate an exit of said conveyor belt and said back side of said perimeter wall of said trough is positioned proximate an entrance of said conveyor belt;
a plurality of rollers having an outer wall extending between each of a first end and a second end of said rollers, said outer wall of said rollers being curvilinear such that said rollers each has an elongated cylindrical shape;
said first and second ends of said rollers each being rotatably coupled to an associated one of said first and second lateral sides of perimeter wall of said trough such that said rollers is positioned adjacent to said bottom wall of said trough, said rollers being evenly spaced apart and distributed between said front and back sides of said perimeter wall of said trough such that said rollers transport said bins between said front and back sides of said perimeter wall of said trough;
a plurality of legs, said legs having a top end and a bottom end, said top end of said legs being coupled to said bottom wall of said trough such that said bottom end of said legs abuts a support surface, said legs being evenly spaced apart and distributed between said front and back sides of said perimeter wall of said trough;
said legs having a decreasing length between said front and back sides of said perimeter wall of said trough such that said trough is retained at an angle with respect to the support surface; and
said bins being positioned within said trough proximate said front side of said perimeter wall of said trough after said bins exit said conveyor belt such that said bins roll along said rollers toward said back side of said perimeter wall of said trough wherein said bins are available to be positioned on an entrance to said conveyor belt.
